(19) United States
(12) Patent Application Publication
(10) Pub. No.: US 2009/0223800 A1
(43) Pub. Date: Sep. 10, 2009

(54) IMPACT SENSOR FOR MOVING MACHINE

(75) Inventors: Pang-Chun LIU, Taichung County (TW); Kun-Yuan Chen, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: GOOTEN INNOLIFE CORPORATION, Taichung Hsien (TW)

(21) Appl. No.: 12/203,729

(22) Filed: Sep. 3, 2008

(30) Foreign Application Priority Data
Mar. 6, 2008 (TW) 97203796

(51) Int. Cl. H01H 1/10

(52) U.S. Cl. 200/512

(57) ABSTRACT

An impact sensor for installation in a moving machine to detect an impact includes first and second electrically conductive strip and an insulative layer sandwiched therebetween. The first electrically conductive strip has at least one electrically conductive member facing but insulatively separated by the insulative layer from at least one electrically conductive member of the second electrically conductive strip. The insulative layer has a plurality of through holes, through at least one of which the electrically conductive member of the first electrically conductive strip and the electrically conductive member of the second electrically conductive strip are electrically contactable with each other when the second electrically conductive strip deforms under impact.

### BACKGROUND OF THE INVENTION

1. Field of the Invention

The present invention relates generally to moving machines and more particularly, to an impact sensor for use in a moving machine to detect impacts.

2. Description of the Related Art

A typical impact sensor for use in a moving machine is an infrared design. For example, a robotic vacuum cleaner utilizes two infrared emitters to emit infrared light, and then reads the intersection area of the two light beams emitted by the two infrared emitters and determines the distance of the robotic vacuum cleaner relative to a wall or obstacle subject to the intersection area reading result.

However, if the detected obstacle has a smooth surface that reflects light, the impact sensor may be unable to read the intersection area of the two infrared light beams accurately or may fail to read the intersection area of the two infrared light beams. Therefore, a conventional robotic vacuum cleaner may be unable to detect the presence of an obstacle during its movement. Improvement in this regard is necessary.

### SUMMARY OF THE INVENTION

The present invention has been accomplished under the circumstances in view. It is the main objective of the present invention to provide an impact sensor for a moving machine, which can accurately detect the presence of any obstacle, having excellent detection sensitivity.

To achieve this objective of the present invention, the impact sensor for installation in a moving machine to detect an impact comprises first and second electrically conductive strips and an insulative layer sandwiched therebetween. The first electrically conductive strip has a strip body, on one side of which at least one electrically conductive member is provided. The second electrically conductive strip has a strip body, on one side of which at least one electrically conductive member facing the at least one electrically conductive member of the first electrically conductive strip is provided. The insulative layer separates the first electrically conductive member from the second electrically conductive member. The insulative layer has a plurality of through holes, through at least one of which the electrically conductive member of the first electrically conductive strip and the electrically conductive member of the second electrically conductive strip are electrically contactable with each other when the second electrically conductive strip deforms under impact.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is a perspective view of an impact sensor in accordance with a first embodiment of the present invention;

FIG. 2 is an exploded view of the impact sensor in accordance with the first embodiment of the present invention;

FIG. 3 is an exploded front view of the impact sensor in accordance with the first embodiment of the present invention;

FIG. 4 is a sectional elevation of taken along line 4-4 of FIG. 1;

FIG. 5 is similar to FIG. 4, but showing that the metal electrically conductive members of the second electrically conductive strip are respectively forced into contact with the metal electrically conductive members of the first electrically conductive strip upon an impact;

FIG. 6 is an exploded front view of an impact sensor in accordance with a second embodiment of the present invention;

FIG. 7 is a cross sectional view of the impact sensor in accordance with the second embodiment of the present invention; and

FIG. 8 is similar to FIG. 7, but showing that the metal electrically conductive members of the second electrically conductive strip are respectively forced into contact with the metal electrically conductive member of the first electrically conductive strip upon an impact.

### DETAILED DESCRIPTION OF THE INVENTION

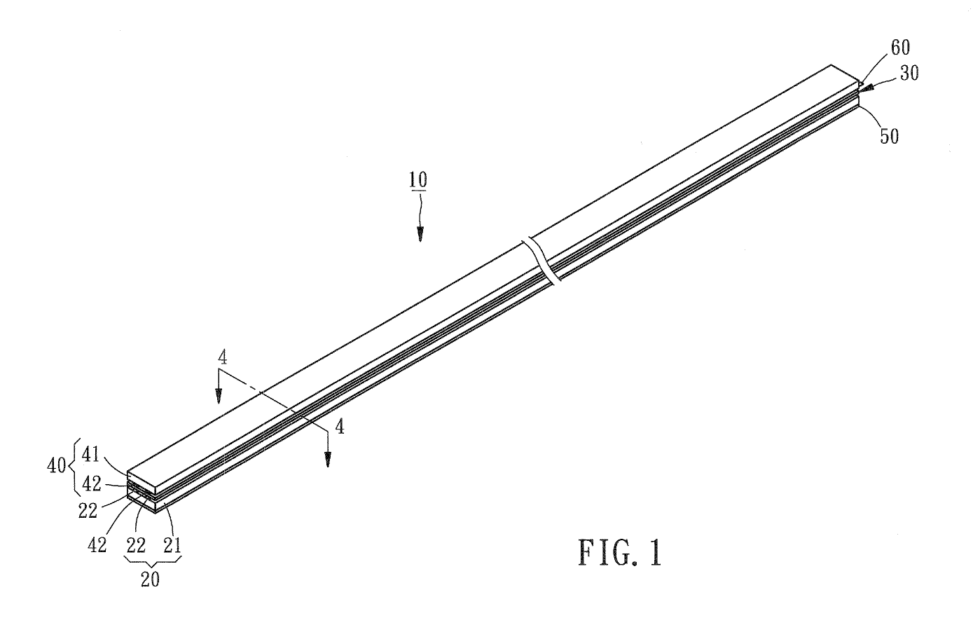

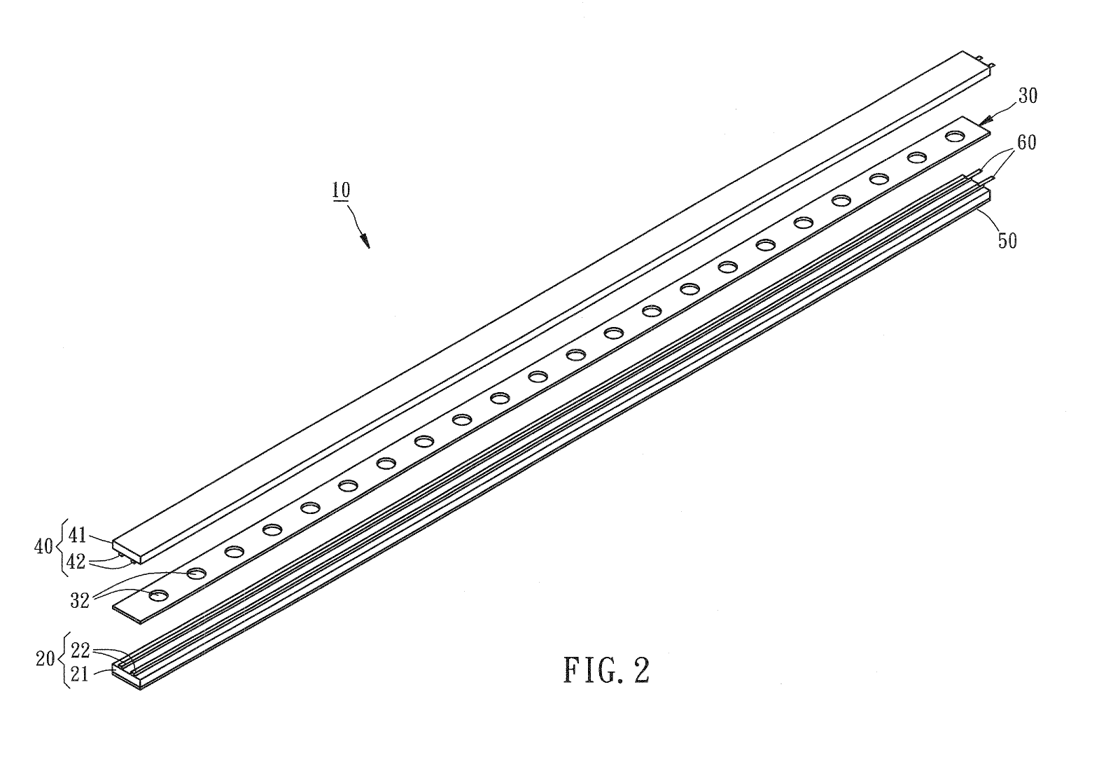

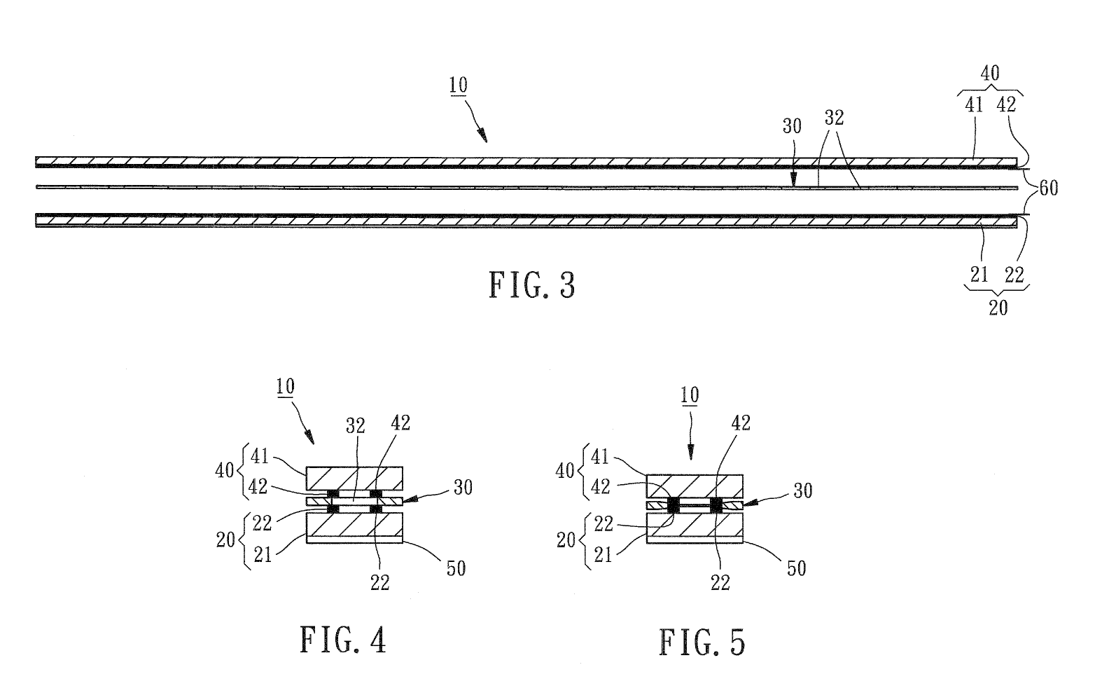

Referring to FIGS. 1-4, an impact sensor 10 for use in a moving machine in accordance with a first embodiment of the present invention is shown comprised of a first electrically conductive strip 20, an insulative layer 30, a second electrically conductive strip 30, a back glue 50, and multiple metal terminals 60.

The first electrically conductive strip 20 includes a flat, narrow, elongated strip body 21 and two line-shaped electrically conductive members 22 protruded from one side, namely, the top side of the strip body 21 in a parallel manner and extending along the length of the strip body 21. The line-shaped electrically conductive members 22 may be prepared from, but not limited to, a metal film or silver adhesive. Preferably, the line-shaped electrically conductive members 22 are made of a metal film in this embodiment. Further, according to this embodiment, there are two line-shaped electrically conductive members 22 provided at the strip body 21. However, the amount of the electrically conductive member is not limited to two.

The insulative layer 30 can be a plastic insulative strip. Alternatively, the insulative layer 30 can be prepared from a light curing adhesive. According to this embodiment, the insulative layer 30 is a plastic insulative strip, having its bottom side attached to the line-shaped electrically conductive members 22 of the first electrically conductive strip 20. Further, the insulative layer 30 has through holes 32 cut through the top and bottom sides and arranged in a line along its length. The diameter of the through holes 32 is greater than the distance between the two line-shaped electrically conductive members 22 of the first electrically conductive strip 20.

The second electrically conductive strip 40 includes a flat, narrow, elongated strip body 41 and two line-shaped electrically conductive members 42 protruded from one side, namely, the bottom side of the strip body 41 in a parallel manner and extending along the length of the strip body 41. The line-shaped electrically conductive members 42 of the second electrically conductive strip 40 are attached to the top side of the insulative layer 30 corresponding to the line-shaped electrically conductive members 22 of the first electrically conductive strip 20. Further, the line-shaped electrically conductive members 42 may be prepared from, but not limited to, a metal film or silver adhesive. Preferably, the line-shaped electrically conductive members 42 are made of a metal film in this embodiment. Further, according to this embodiment, there are two line-shaped electrically conductive members 42 provided at the strip body 41. However, the amount of the electrically conductive member 42 used is not limited to two.

The back glue 50 can be applied to the bottom side of the strip body 21 of the first electrically conductive strip 20 or the top side of the strip body 41 of the second electrically conductive strip 40. According to this embodiment, the back glue 50 is applied to the bottom side of the strip body 21 of the first electrically conductive strip 20 for bonding the impact sensor 10 to the outer surface of the housing of a moving machine (not shown).

The metal terminals 60 are respectively connected to the line-shaped electrically conductive members 22 of the first electrically conductive strip 20 and the line-shaped electrically conductive members 42 of the second electrically conductive strip 40 for electrically connecting the impact sensor 10 to the internal electric circuit of the moving machine in which the impact sensor 10 is installed.

Referring to FIG. 5, when the second electrically conductive strip 40 is forded by an external pressure toward the first electrically conductive strip 20, for example, when the housing of the moving machine touched a wall or obstacle to compress the second electrically conductive strip 40, the line-shaped electrically conductive members 42 of the second electrically conductive strip 40 will be forced to project through at least one of the through holes 32 of the insulative layer 30 into contact with the line-shaped electrically conductive members 22 of the first electrically conductive strip 20, thereby causing a short circuit and further triggering of the moving machine.

Multiple impact sensors 10 of the aforesaid design may be installed in the housing of a moving machine at different locations. When one impact sensor 10 is induced, the moving machine determines the direction of the obstacle subject to the location of the induced impact sensor 10. Therefore, the use of the present invention in a moving machine enables the moving machine to accurately detect any obstacle, eliminating the detection problem of a conventional infrared type impact sensor.

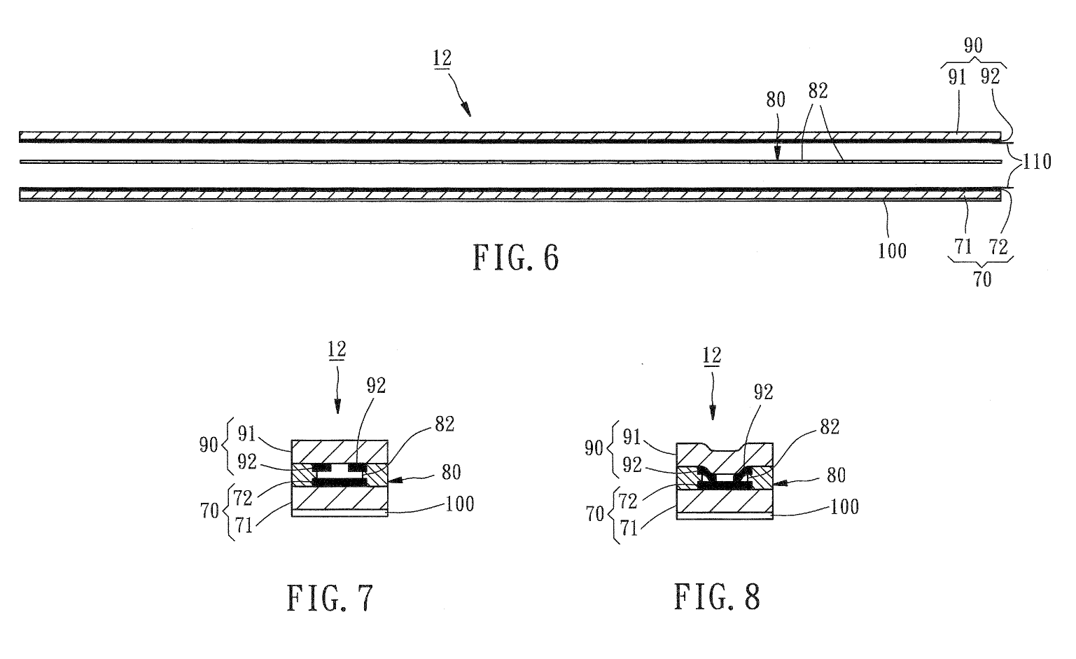

FIGS. 6-8 illustrate an impact sensor 12 in accordance with a second embodiment of the present invention. Similar to the aforesaid first embodiment, the impact sensor 12 is comprised of a first electrically conductive strip 70, an insulative layer 80, a second electrically conductive strip 90, a back glue 110, and multiple metal terminals 110. According to this embodiment, the first electrically conductive strip 70 comprises a flat, narrow, elongated strip body 71 and one single electrically conductive member 72 protruded from one side, namely, the top side of the strip body 71 and extending along the length of the strip body 71. The electrically conductive member 72 of the first electrically conductive strip 70 may be prepared from a metal film or silver adhesive. According to this embodiment, the electrically conductive member 72 is made of silver adhesive. The insulative layer 80 can be a plastic insulative strip. Alternatively, the insulative layer 80 can be prepared from a light curing adhesive. According to this embodiment, the insulative layer 80 is prepared from a light curing adhesive. Further, the insulative layer 80 has through holes 82 cut through the top and bottom sides and arranged in a line along its length. The second electrically conductive strip 90 comprises a flat, narrow, elongated strip body 91 and two electrically conductive members 92 protruded from one side, namely, the bottom side of the strip body 91 and extending along the length of the strip body 91. The electrically conductive members 92 of the second electrically conductive strip 90 are attached to the top side of the insulative layer 80 corresponding to the electrically conductive member 72 of the first electrically conductive strip 70. Further, the electrically conductive members 92 may be prepared from a metal film or silver adhesive. According to this embodiment, the electrically conductive members 92 are made of silver adhesive. Further, the diameter of the through holes 82 of the insulative layer 80 is approximately equal to the transverse width of the electrically conductive member 72 of the first electrically conductive strip 70 and greater than the transverse distance between the two electrically conductive members 92 of the second electrically conductive strip 90. This second embodiment achieves the same effect as the aforesaid first embodiment.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An impact sensor for installation in a moving machine to detect an impact, the impact sensor comprising:
a first electrically conductive strip having a strip body and at least one electrically conductive member at one side of the strip body;
a second electrically conductive strip having a strip body and at least one electrically conductive member at one side of the strip body of the second electrically conductive strip; and
an insulative layer sandwiched between the first electrically conductive strip and the second electrically conductive strip, the insulative layer having a plurality of through holes, through at least one of which the electrically conductive member of the first electrically conductive strip and the electrically conductive member of the second electrically conductive strip are electrically contactable with each other when the second electrically conductive strip deforms under impact.

2. The impact sensor as claimed in claim 1, wherein the insulative layer is formed of a plastic insulative strip or a light curing adhesive.

3. The impact sensor as claimed in claim 1, wherein the first electrically conductive strip comprises a plurality of said electrically conductive members that are arranged in parallel.

4. The impact sensor as claimed in claim 3, wherein the through holes of the insulative layer have a diameter greater than a distance between two adjacent electrically conductive members of the first electrically conductive strip.

5. The impact sensor as claimed in claim 1, wherein the second electrically conductive strip comprises a plurality of said electrically conductive members that are arranged in parallel.

6. The impact sensor as claimed in claim 5, wherein the through holes of the insulative layer have a diameter greater than a distance between two adjacent electrically conductive members of the second electrically conductive strip.

7. The impact sensor as claimed in claim 1, wherein the electrically conductive member of the first electrically conductive strip is formed of a metal film or a silver adhesive.

8. The impact sensor as claimed in claim 1, wherein the electrically conductive member of the second electrically conductive strip is formed of a metal film or a silver adhesive.

9. The impact sensor as claimed in claim 1, further comprising a plurality of metal terminals respectively electrically connected to the electrically conductive member of the first electrically conductive strip and the electrically conductive member of the second electrically conductive strip.

10. The impact sensor as claimed in claim 1, further comprising a back glue applied to one side of one of the first electrically conductive strip and the second electrically conductive strip.
